(19) United States
(12) Patent Application Publication
(10) Pub. No.: US 2008/0079666 A1
(43) Pub. Date: Apr. 3, 2008

(54) Plasma display device

(75) Inventors: Tomonari Misawa, Hyogo (JP); Shigeo Kasahara, Hyogo (JP)

Correspondence Address: MCDERMOTT WILL & EMERY LLP, 600 13TH STREET, N.W., WASHINGTON, DC, 20005-3096, US

(73) Assignee: FUJITSU HITACHI PLASMA DISPLAY LIMITED

(21) Appl. No.: 11/797,547

(22) Filed: May 4, 2007

(30) Foreign Application Priority Data
Sep. 29, 2006 (JP) 2006-268083

(51) Int. Cl. G09G 3/28

(52) U.S. Cl. 345/60

(57) ABSTRACT

A plasma display device includes a plasma display panel having a discharge space filled with a discharge gas, the discharge space being formed inside of the panel formed of a front-side substrate assembly and a rear-side substrate assembly bonded to each other, the panel having first and second holes each extending to the discharge space, the first and second holes being coupled to each other via a pipe on the outside of the panel, wherein the first hole is in a position higher than the second hole in a normal mounting state of the panel, or a gas circulating mechanism for circulating the discharge gas is provided in the pipe.

### CROSS-REFERENCE TO RELATED APPLICATION

This application is related to Japanese Patent Application No. 2006-268083 filed on Sep. 29, 2006, whose priority is claimed and the disclosure of which is incorporated by reference in its entirety.

### BACKGROUND OF THE INVENTION

1. Field of the Invention

The present invention relates to a plasma display device having a plasma display panel (hereinafter, referred to as PDP).

2. Description of Related Art

FIG. 9 is a perspective view showing a structure of a conventional PDP. The PDP has a structure formed by bonding a front-side substrate assembly 1 and a rear-side substrate assembly 2 to each other. The front-side substrate assembly 1 includes a front-side substrate 1a which is a glass substrate, display electrodes 3 each made of a transparent electrode 3a and a bus electrode 3b and arranged on the front-side substrate 1a, and a dielectric layer 4 covering the display electrodes 3. Further, a protective layer 5 which is a magnesium oxide layer having a high secondary electron emission coefficient is formed on the dielectric layer 4. In the rear-side substrate assembly 2, address electrodes 6 are disposed on a rear-side substrate 2a which is a glass substrate so that the address electrodes 6 cross the display electrodes 3 at a right angle, and barrier ribs 7 for defining light emitting regions are provided between neighboring address electrodes 6 and red-, green-, and blue-emitting phosphor layers 8 are formed on the address electrodes 6 in regions divided by the barrier ribs 7. A Ne—Xe gas as discharge gas is introduced in an air-tight discharge space formed in a structure formed of the front-side substrate assembly 1 and the rear-side substrate assembly 2 bonded to each other. Although not shown, it should be noted that the address electrodes 6 are covered with a dielectric layer, and the barrier ribs 7 and the phosphor layer 8 are formed on the dielectric layer.

In such a PDP, by applying a voltage between the address electrode 6 and the display electrode 3, a discharge for addressing (address discharge) is generated. By applying a voltage between a pair of display electrodes 3, a reset discharge or sustain discharge for display is generated.

The PDP generates heat by the various discharges. The heat generated by the discharge is released from a radiator plate attached to the rear-side substrate assembly 2 or the front-side substrate assembly 1.

In the case where heat dissipation is insufficient, the temperature of the PDP rises. The temperature rise in the PDP may cause various problems such as deterioration in luminous efficiency, a change in voltage margin, and acceleration in time degradation. The problems become serious at the time of high-luminance lighting, where discharge is performed long. A technique for suppressing the temperature rise in the PDP is therefore in demand.

### SUMMARY OF THE INVENTION

The present invention has been achieved in consideration of such circumstances and an object of the invention is to provide a plasma display device capable of suppressing temperature rise in a PDP.

A plasma display device of the present invention includes a PDP having a discharge space filled with a discharge gas, the discharge space being formed inside of the PDP formed of a front-side substrate assembly and a rear-side substrate assembly bonded to each other, the PDP having first and second holes each extending to the discharge space, the first and second holes being coupled to each other via a pipe on the outside of the PDP, wherein the first hole is in a position higher than the second hole in a normal mounting state of the PDP, or a gas circulating mechanism for circulating the discharge gas is provided in the pipe.

The plasma display device of the invention has the first and second holes coupled to each other via the pipe on the outside of the PDP. The discharge gas goes out from the first hole (or the second hole) to the outside of the PDP, passes through the pipe, and returns to the inside of the PDP via the second hole (or the first hole). Since the temperature on the outside of the PDP is usually lower than that on the inside of the PDP, the discharge gas is cooled on the outside of the PDP and, after that, returns to the inside of the PDP. By such a principle, the heat in the PDP is released to the outside of the PDP, and the temperature rise in the PDP is suppressed.

### BRIEF DESCRIPTION OF THE DRAWINGS

FIG. 1 is a plan view from the front side of a plasma display device of a first embodiment of the invention;

FIG. 2 is a plan view from the front side of a plasma display device of a second embodiment of the invention;

FIG. 3 is a plan view from the front side of a plasma display device of a third embodiment of the invention;

FIG. 4 is a plan view from the front side of a plasma display device of a fourth embodiment of the invention;

FIG. 5 is a plan view from the front side of a PDP of an embodiment of an invention from another viewpoint;

FIG. 6A is an enlarged view of an area 37 defined by dotted line in FIG. 5, and FIG. 6B is a cross sectional view taken along line I-I of FIG. 6A;

FIG. 7A is an enlarged view of the area 37 defined by dotted line in FIG. 5, and FIG. 7B is a cross sectional view taken along line I-I of FIG. 7A;

FIG. 8A is an enlarged view of the area 37 defined by dotted line in FIG. 5, and FIGS. 8B and 8C are cross sectional views taken along lines I-I and II-II, respectively, of FIG. 8A; and

FIG. 9 is a perspective view showing a structure of a conventional PDP.

### DESCRIPTION OF THE PREFERRED EMBODIMENTS

A plasma display device of an embodiment of the present invention includes a PDP having a discharge space filled with a discharge gas, the discharge space being formed inside of the PDP formed of a front-side substrate assembly and a rear-side substrate assembly bonded to each other, the PDP having first and second holes each extending to the discharge space, the first and second holes being coupled to each other via a pipe on the outside of the PDP, wherein the first hole is in a position higher than the second hole in a normal mounting state of the PDP, or a gas circulating mechanism for circulating the discharge gas is provided in the pipe.

The plasma display device of the embodiment has the first and second holes coupled to each other via the pipe on the outside of the PDP. The discharge gas goes out from the first hole (or the second hole) to the outside of the PDP, passes through the pipe, and returns to the inside of the PDP via the second hole (or the first hole). Since the temperature on the outside of the PDP is usually lower than that on the inside of the PDP, the discharge gas is cooled on the outside of the PDP and, after that, returns to the inside of the PDP. By such a principle, the heat in the PDP is released to the outside of the PDP, and the temperature rise in the PDP is suppressed.

Migration of the discharge gas in the pipe occurs (1) in the case where the first hole is in a position higher than the second hole in a normal mounting state of the PDP, or (2) in the case where the gas circulating mechanism for circulating the discharge gas is provided in the pipe.

The principle of occurrence of migration of the discharge gas in the case (1) is as follows. When the temperature of the discharge gas rises, the density of the discharge gas becomes low, and the discharge gas moves upwards. When the temperature of the discharge gas lowers, the density of the discharge gas becomes high, and the discharge gas moves downwards. Consequently, by providing the first hole in a position higher than the second hole, the flow of the discharge gas from the first hole to the second hole is created. The “normal mounting state” denotes an expected mounting state of the PDP in use. In the case of a rectangular PDP, the normal mounting state is usually a state where the PDP is mounted with the long side positioned down. In the case of a PDP which is expected to be used in a state where the PDP stands with its short side down, the state where the PDP stands with its short side down is the normal mounting state. Also in the case of a PDP of a shape other than rectangular shape, it is expected that the PDP is used in a certain mounting state, and the expected state is the normal mounting state.

In the case of (2), the discharge gas migrates through the pipe from the first hole toward the second hole or from the second hole toward the first hole by the action of the gas circulating mechanism such as a fan or a pump.

Preferred embodiments of the invention will be described below.

Preferably, the first and second holes are provided in diagonal positions of the rear-side substrate assembly. In this case, the discharge gas migrates from end to end in the discharge space, and suppression of the temperature rise in the whole panel is expected.

Preferably, at least one of a gas cooling mechanism a gas purifying mechanism, and a pressure control mechanism is provided in the pipe. By providing the gas cooling mechanism, the discharge gas is further cooled, and the temperature rise in the PDP can be further suppressed. By providing the gas purifying mechanism, impurities generated in the discharge space can be removed. By providing the pressure control mechanism, the discharge gas pressure in the discharge space can be adjusted.

Preferably, the PDP has a display area, a seal layer provided so as to surround the display area, and an intermediate area between the display area and the seal layer, the first hole comprises plural portions provided in the intermediate area in an upper part of the PDP in the normal mounting state of the PDP, and the second hole comprises plural portions provided in the intermediate area in a lower part of the PDP in the normal mounting state of the PDP. In this case, the flow of the discharge gas in the discharge space can be made more uniform, the temperature rise in the PDP as a whole can be suppressed effectively, and variations in the temperature in a plane in the discharge space can be reduced.

Preferably, the PDP has a display area, a seal layer provided so as to surround the display area, and an intermediate area between the display area and the seal layer, and a wall part blocking the migration of the discharge gas is provided in the intermediate area on a side of the PDP in the normal mounting state of the PDP, the first hole is provided in a position higher than the wall part in the normal mounting state of the PDP, and the second hole is provided in a position lower than the wall part in the normal mounting state of the PDP. In this case, the discharge gas can be led to a display area, which becomes the hottest in the PDP, and the temperature rise in the display area can be effectively suppressed.

Preferably, the first and second holes are provided for the rear-side substrate assembly. In this case, the pipe connecting the first and second holes can be prevented from being projected from the front side.

The preferred embodiments shown above can be properly combined.

Embodiments of the present invention will be described below with reference to the drawings. The configurations shown in the drawings and the following description are illustrative, and the scope of the invention is not limited by the drawings and the following description. The following embodiments relate to, as examples, a plasma display device having a three-electrode surface discharge type PDP in which a pair of display electrodes, a dielectric layer, and a protective layer are provided for a front-side substrate assembly, address electrodes, a dielectric layer, barrier ribs, and a phosphor layer are formed in a rear-side substrate assembly, and discharge cells exist at intersections of the display electrodes and the address electrodes. The invention, however, is not limited to the configuration and is also applied to a plasma display device having a PDP of another configuration.

### 1. First Embodiment

### 1-1. Structure of Plasma Display Device

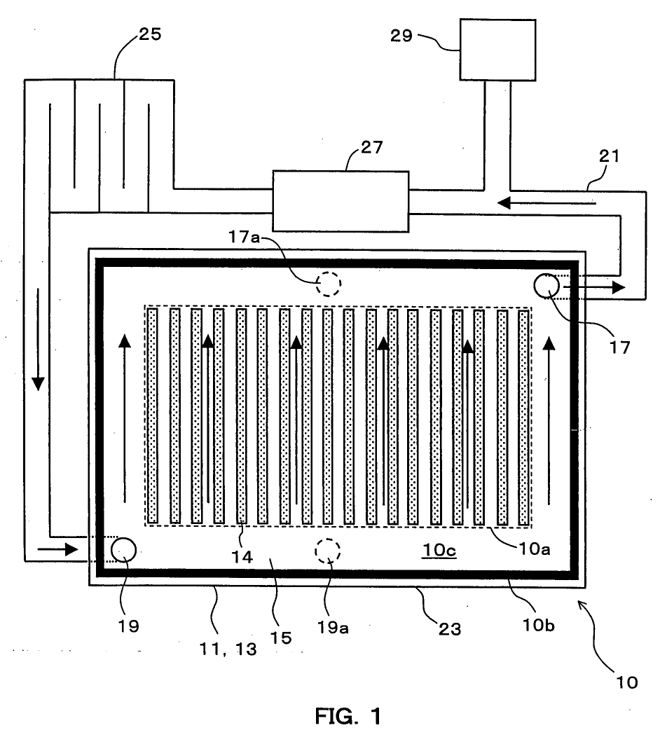

The structure of a plasma display device of a first embodiment of the invention will be described with reference to FIG. 1. FIG. 1 is a plan view from the front side of a plasma display device of the embodiment.

The plasma display device of the embodiment has a PDP 10 having a discharge space 15 filled with a discharge gas. The discharge space 15 is formed inside of the PDP 10 formed of a front-side substrate assembly 11 and a rear-side substrate assembly 13 bonded to each other. The PDP 10 has a first hole 17 and a second hole 19 each extending to the discharge space 15. The first and second holes 17 and 19 are coupled to each other via a pipe 21 outside the PDP 10. In a normal mounting state of the PDP 10, the first hole 17 is in a position higher than the second hole 19. The PDP 10 has a rectangular shape, and the normal mounting state is a state where the PDP 10 is upright with its one of long sides 23 down.

The PDP 10 has a display area 10a, a seal layer 10b provided so as to surround the display area 10a, and an intermediate area 10c between the display area 10a and the seal layer 10b. In FIG. 1, the display area 10a is an area defined by dotted line. In the display area 10a, a plurality of discharge cells defined at intersections of display electrodes (not shown) of the front-side substrate assembly 11 and address electrodes (not shown) of the rear-side substrate assembly 13 exist. Barrier ribs 14 in the rear-side substrate assembly 13 are formed in the display area 10a. Although the barrier ribs 14 in a stripe form are shown in FIG. 1, the shape of the barrier ribs 14 is not limited to a strip form but may be a lattice form (box or waffle form). The barrier ribs 14 may be formed also in the intermediate area 10c.

The first and second holes 17 and 19 are formed in the rear-side substrate assembly 13. The first hole 17 is formed in the intermediate area 10c in the upper part of the PDP 10 in the normal mounting state of the PDP 10. The second hole 19 is formed in the intermediate area 10c in the lower part of the PDP 10 in the normal mounting state of the PDP 10. The first and second holes 17 and 19 are disposed at diagonal positions of the PDP 10.

The first and second holes 17 and 19 are not limited to those shown in FIG. 1. The first and second holes 17 and 19 may be provided in other positions, as long as the first hole 17 is provided in a position higher than the second hole 19 in the normal mounting state. Therefore, the first and second holes 17 and 19 may be provided in the display area 10a or in positions other than the diagonal positions. The first and second holes 17 and 19 may be provided, for example, as shown in circles 17a and 19a of dotted lines in FIG. 1, in the center of the long side of the PDP 10 in the upper and lower parts in the intermediate areas 10c. At least one of the first and second holes 17 and 19 may be provided in the front-side substrate assembly 11.

As to the pipe 21, the dimensions, material, and the like are not limited as long as the discharge gas can be passed through the pipe 21. The pipe 21 can be formed of metal, glass, plastic, or the like. In the pipe 21, a gas cooling mechanism 25, a gas purifying mechanism 27, and a pressure control mechanism 29 are provided.

The gas cooling mechanism 25 is a mechanism for cooling the discharge gas flowing through the pipe 21 and is, for example, a cooling mechanism by water cooling, air cooling, or cooling by a Peltier device. The gas cooling mechanism 25 is not always necessary, but may be provided as necessary, because heat can be released from the surface of the pipe 21 even though the gas cooling mechanism 25 is not provided.

The gas purifying mechanism 27 is a mechanism of purifying the discharge gas by removing impurity gas made of carbon dioxide, hydrocarbon, or the like generated in the discharge space 15 when the phosphor layer and the protective film are irradiated with vacuum ultraviolet rays. An example of the gas purifying mechanism 27 is a molecular sieve for absorbing the impurity gas. Because the impurity gas is the cause of time degradation of the PDP 10, the time degradation of the PDP 10 can be suppressed by removing the impurity gas. In the case where purification of the discharge gas is unnecessary from the viewpoint of the required life span of the PDP 10 or the like, the gas purifying mechanism 27 may not be provided.

The pressure control mechanism 29 is a mechanism for controlling the discharge gas pressure in the discharge space 15. The pressure control mechanism 29 has preferably both of the function of decreasing the discharge gas pressure and the function of increasing the discharge gas pressure, but may have only one of the functions. The pressure control mechanism 29 is, for example, a molecular sieve for absorbing the discharge gas. In this case, by absorbing the discharge gas, the discharge gas pressure is decreased. By heating the molecular sieve, the absorbed discharge gas is released, and the discharge gas pressure is increased. The pressure control mechanism 29 may be, for example, a mechanism having the structure like an injection syringe and having the function of sucking and releasing the discharge gas. In this case, by sucking the discharge gas, the discharge gas pressure is decreased. By releasing the discharge gas, the discharge gas pressure is increased.

It is known that, generally, when discharge occurs, the protective layer having high secondary electron emission coefficient and exposed to the discharge space 15 is sputtered, the thickness of the protective layer is decreased, and the discharge start voltage rises. It is also known that as the discharge gas pressure decreases, the discharge start voltage decreases. Therefore, by decreasing the discharge gas pressure along with the length of the operating time of the PDP 10, the discharge start voltage can be made substantially constant. The discharge gas pressure may be intermittently decreased in a stepwise each time the discharge time elapses by predetermined time (for example, 1,000 hours), or continuously decreased little by little.

In the case where the control of the discharge gas pressure is unnecessary from the viewpoint of the required life span of the PDP 10 or the like, the pressure control mechanism 29 may not be provided.

### 1-2. Method of Producing Plasma Display Device

An example of a method of producing a plasma display device of the invention will now be described.

First, display electrodes, a dielectric layer, and a protective layer are formed on a front-side substrate which is a glass substrate, and thereby the front-side substrate assembly 11 is formed. Next, address electrodes, a dielectric layer, barrier ribs, and a phosphor layer are formed on a rear-side substrate which is a glass substrate, and thereby the rear-side substrate assembly 13 is formed. After that, a paste for forming the seal layer 10b is applied to the rear-side substrate assembly 13, the front-side substrate assembly 11 and the rear-side substrate assembly 13 are overlaid so that the display electrodes and the address electrodes cross each other, and are sintered in such a state, and thereby a panel having therein the air-tight discharge space 15 is formed. The discharge space 15 is evacuated, and the discharge gas is introduced into the discharge space 15. The discharge gas may be introduced into the discharge space 15 via the first hole 17, the second hole 19, or a separately-provided hole extending to the discharge space 15. After introduction of the discharge gas, all of the holes extending to the discharge space 15 are closed. The above-described processes can be performed by a known method.

By attaching the pipe 21 in which the gas cooling mechanism 25, gas purifying mechanism 27, and pressure control mechanism 29 are preliminarily provided to the first hole 17 or the second hole 19 in the PDP formed as described above, the production of the plasma display device of the embodiment is completed. Impurities in the pipe 21 are removed in advance, and a discharge gas having the same components as those of the discharge gas in the discharge space 15 is encapsulated in the pipe 21. In place of encapsulating the discharge gas in the pipe 21 in advance, the pressure of the discharge gas in the discharge space 15 may be set to be higher in consideration of the volume in the pipe 21.

Although the pipe 21 is attached after the discharge gas is introduced in the discharge space 15, it is also possible to perform evacuation and perform introduction of the discharge gas after the pipe 21 is attached.

### 1-3. Principle

The principle of migration of the discharge gas to the pipe 21 via the first hole 17 and from the pipe 21 to the second hole 19 in the plasma display device of the embodiment will be described.

When discharge occurs in the discharge space 15 in the PDP 10, the discharge gas is heated and expanded, and the density of the discharge gas decreases. The discharge gas whose density decreases moves upwards in the discharge space 15 as shown by arrows in FIG. 1 and migrates from the first hole 17 to the pipe 21. Since the pipe 21 is provided on the outside of the PDP 10, the temperature of the pipe 21 is lower than that in the discharge space 15. Consequently, the discharge gas is cooled in the pipe 21, the volume decreases, and the density becomes higher. The gas whose density becomes higher moves downwards in the pipe 21 and returns to the discharge space 15 via the second hole 19. Thus, the flow of the discharge gas is generated for the reason that the first hole 17 is in the position higher than the second hole 19 in the normal mounting state of the plasma display device of the embodiment.

### 2. Second Embodiment

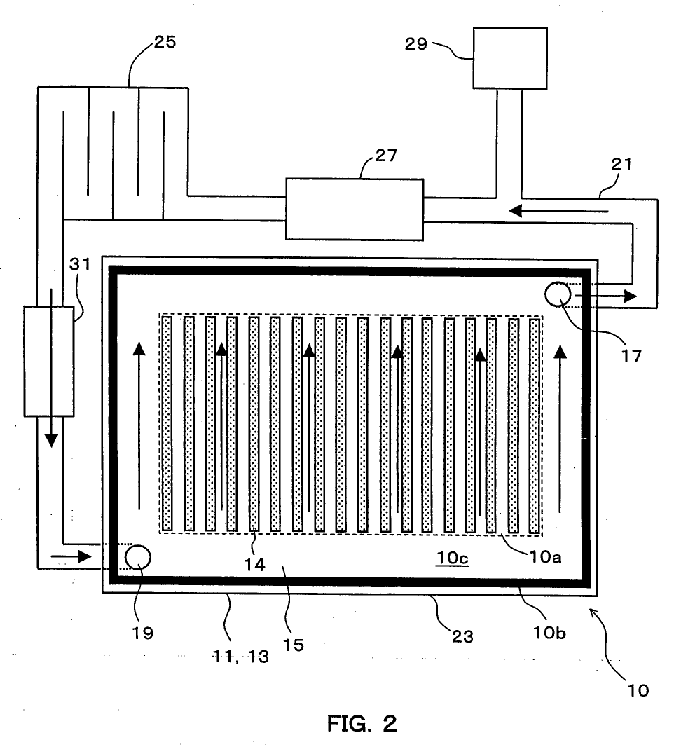

The structure of a plasma display device of a second embodiment of the invention will be described with reference to FIG. 2. FIG. 2 is a plan view from the front side of a plasma display device of the embodiment.

The plasma display device of the second embodiment is similar to that of the first embodiment except for the point that a gas circulating mechanism 31 for making the discharge gas circulate in the pipe 21 is provided. In the second embodiment, the discharge gas migrates in the pipe 21 by the action of the gas circulating mechanism 31. Consequently, the first hole 17 does not have to be in a position higher than the second hole 19 in the normal mounting state. The first and second holes 17 and 19 may be at the same height, or the second hole 19 may be in a position higher than the first hole 17. Configuration of the gas circulating mechanism 31 is not limited as long as the gas circulating mechanism 31 have the function of making the discharge gas migrate from the first hole 17 via the pipe 21 toward the second hole 19 or from the second hole 19 via the, pipe 21 toward the first hole 17. Examples of the gas circulating mechanism 31 are a fan and a pump.

The plasma display device of the second embodiment can be produced in a manner similar to the plasma display device of the first embodiment except that the pipe 21 with the gas circulating mechanism 31 is used.

### 3. Third Embodiment

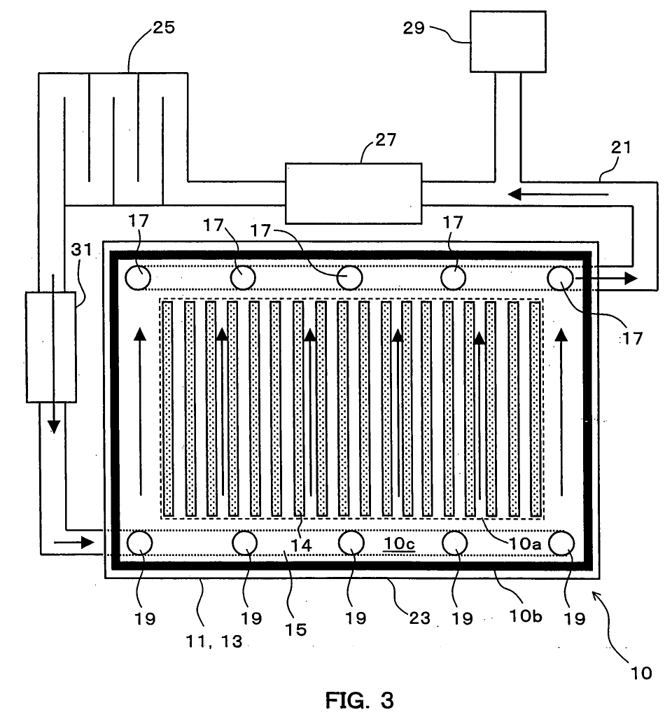

The structure of a plasma display device of a third embodiment of the invention will be described with reference to FIG. 3. FIG. 3 is a plan view from the front side of a plasma display device of the embodiment.

The plasma display device of the third embodiment is similar to that of the second embodiment except for the point that the first hole 17 comprises plural portions (five in FIG. 3) provided in the intermediate area 10c in the upper part of the PDP 10 in the normal mounting state of the PDP 10 and the second hole 17 comprises plural portions (five in FIG. 3) provided in the intermediate area 10c in the lower part of the PDP 10 in the normal mounting state of the PDP 10. The plural portions of the first hole 17 and the plural portions of the second hole 19 are connected to the same pipe 21. Further, the plural portions of the first hole 17 are disposed so that an interval of the portions is even, and the plural portions of the second hole 19 are disposed so that an interval of the portions is even. With such a configuration, the flow of the discharge gas in the discharge space 15 can be made more uniform, and the efficiency of heat dissipation can be improved. In addition, variations in the temperature in a plane in the discharge space 15 can be reduced. The number of the portions of the first hole 17 may be the same as or different from that of the portions of the second hole 19.

The plasma display device of the third embodiment can be produced by a method similar to that of the plasma display device of the second embodiment, except that the pipe 21 having a branch at its ends so as to be attached to the plural portions of the first hole 17 and the plural portions of the second hole 19 is used.

The case where the plasma display device has the gas circulating mechanism 31 has been described above as an example. However, the configuration having no gas circulating mechanism 31 as in the first embodiment is also possible. In this case, by a principle similar to that of the first embodiment, migration of the discharge gas from the first hole 17 via the pipe 21 to the second hole 19 occurs.

### 4. Fourth Embodiment

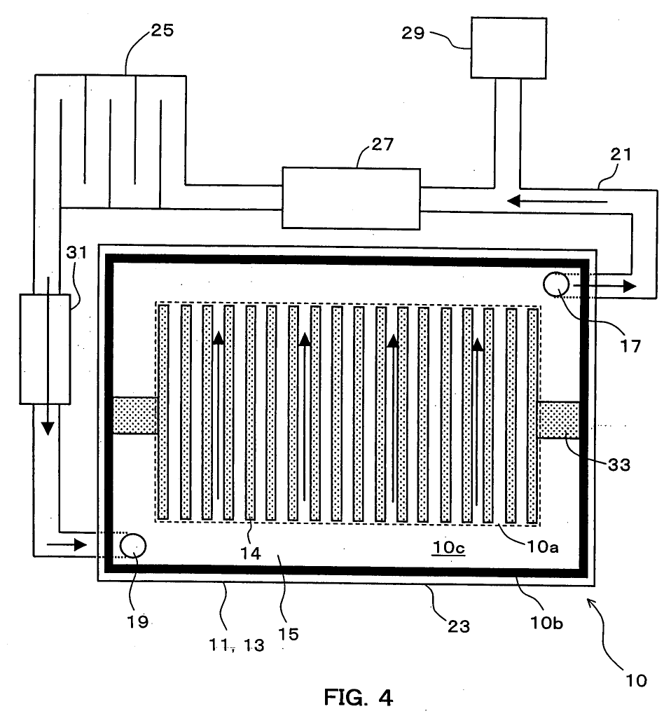

The structure of a plasma display device of a fourth embodiment of the invention will be described with reference to FIG. 4. FIG. 4 is a plan view from the front side of the plasma display device of the fourth embodiment.

The plasma display device of the fourth embodiment is similar to the second embodiment except for the point that a wall 33 blocking the migration of the discharge gas is provided in the intermediate area 10c in side parts in the PDP 10 in the normal mounting state of the PDP 10. The first hole 17 is provided in a position higher than the wall 33 in the normal mounting state of the PDP 10, and the second hole 19 is provided in a position lower than the wall 33 in the normal mounting state of the PDP 10.

In the second embodiment, since there is no wall 33, a part of the discharge gas passes through the intermediate area 10c in side parts in the PDP 10 and migrates between the first and second holes 17 and 19. Since no discharge occurs in the intermediate area 10c, generally, the temperature in the intermediate area 10c is low, and the discharge gas passing through the intermediate area 10c does not contribute to suppression in the temperature rise of the PDP 10 so much. In the fourth embodiment, the wall 33 is provided in the intermediate area 10c in the side part of the PDP 10, the discharge gas cannot migrate between the first and second holes 17 and 19 via the intermediate area 10c in the side part of the PDP 10. The discharge gas is inevitably guided to the display area 10a, passes through the display area 10a, and migrates between the first and second holes 17 and 19. Therefore, according to the fourth embodiment, the temperature rise in the PDP 10 can be suppressed more efficiently.

The plasma display device of the fourth embodiment can be produced in a manner similar to the plasma display device of the second embodiment, except that the wall 33 is also formed at the time of forming the barrier ribs 14, or a step of forming the wall 33 is separately provided.

The case where the plasma display device has the gas circulating mechanism 31 has been described above as an example. However, the configuration having no gas circulating mechanism 31 as in the first embodiment is also possible. In this case, by a principle similar to that of the first embodiment, migration of the discharge gas from the first hole 17 via the pipe 21 to the second hole 19 occurs, and migration of the discharge gas from the second hole 19 to the first hole 17 via the display area 10a occurs in the discharge space 15.

### 5. Others

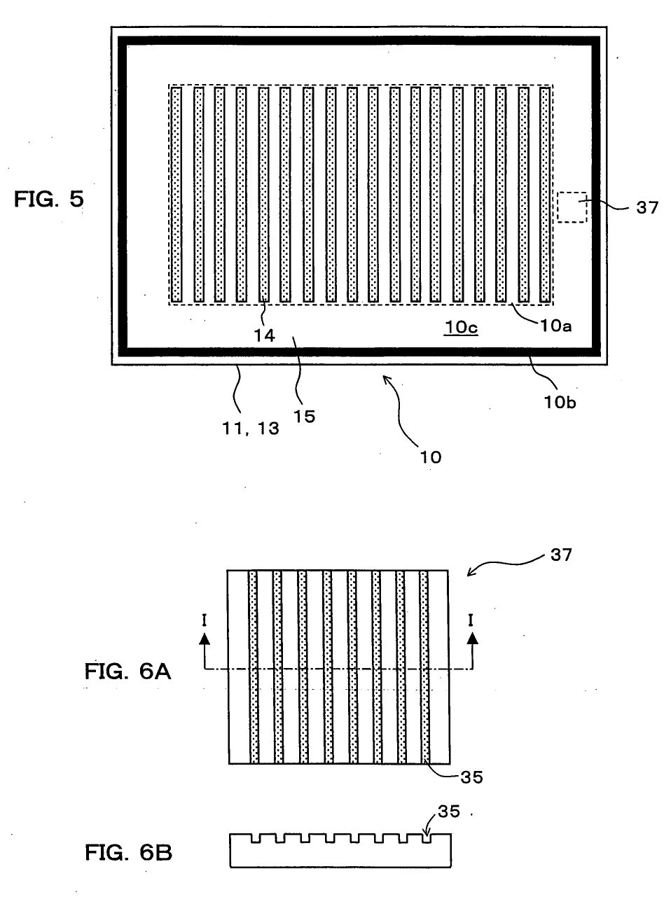

An embodiment of an invention for suppressing temperature rise in the PDP from a viewpoint different from that of the first to fourth embodiments will be described with reference to FIG. 5. FIG. 5 is a plan view from the front side of the PDP of the embodiment.

The PDP 10 of the embodiment has a discharge space 15 filled with a discharge gas, and the discharge space 15 is formed inside of the PDP 10 formed of the front-side substrate assembly 11 and the rear-side substrate assembly 13 bonded to each other. The PDP 10 has a display area 10a, a seal layer 10b provided so as to surround the display area 10a, and an intermediate area 10c between the display area 10a and the seal layer 10b. In the intermediate area 10c, grooves 35 in stripes or lattice made by a plurality of lines are formed. The grooves 35 are formed in at least one of the front-side substrate assembly 11 and the rear-side substrate assembly 13. The grooves 35 are preferably formed in the dielectric layer in the front-side substrate assembly 11 or the rear-side substrate assembly 13, but they may be formed in a glass substrate. The grooves 35 may be formed entirely or partly in the intermediate area 10c.

The principle of suppression of the temperature rise in the PDP in the embodiment is as follows. Generally, in the display area 10a where discharge occurs, a large amount of heat is generated and the temperature of the discharge gas largely rises. On the other hand, in the intermediate area 10c where no discharge occurs, the heat generation amount is small and the temperature of the discharge gas does not rise so much. Consequently, the discharge gas temperature gradient occurs between the display area 10a and the intermediate area 10c, it causes convection between the display area 10a and the intermediate area 10c, the discharge gas in the display area 10a migrates to the intermediate area 10c, and the discharge gas in the intermediate area 10c migrates to the display area 10a. The discharge gas having migrated to the intermediate area 10c dissipates heat to the front-side and rear-side substrate assemblies 11 and 13 in the intermediate area 10c, so that the temperature of the discharge gas decreases. In the embodiment, since the grooves 35 are formed in the intermediate area 10c, the contact area between the discharge gas in the intermediate area 10c and the front-side or rear-side substrate assembly 11 or 13 is large, so that heat dissipation to the front-side or rear-side substrate assembly 11 or 13 is also large. Therefore, the temperature of the discharge gas having migrated to the intermediate area 10c drops promptly in the intermediate area 10c, and convection is accelerated. It suppresses temperature rise in the PDP 10.

Since the protective layer of the front-side substrate assembly 11 and the phosphor layer of the rear-side substrate assembly 13 are apart from the surfaces of the front-side and rear-side substrate assemblies 11 and 13 facing the outside, heat accumulated in the protective layer and the phosphor layer is not easily released from the surfaces facing the outside. However, in the embodiment, the discharge gas takes the heat from the protective layer and the phosphor layer, and the heat accumulated in the discharge gas is released in the intermediate area 10c. Consequently, heat can be efficiently removed from the protective layer and the phosphor layer.

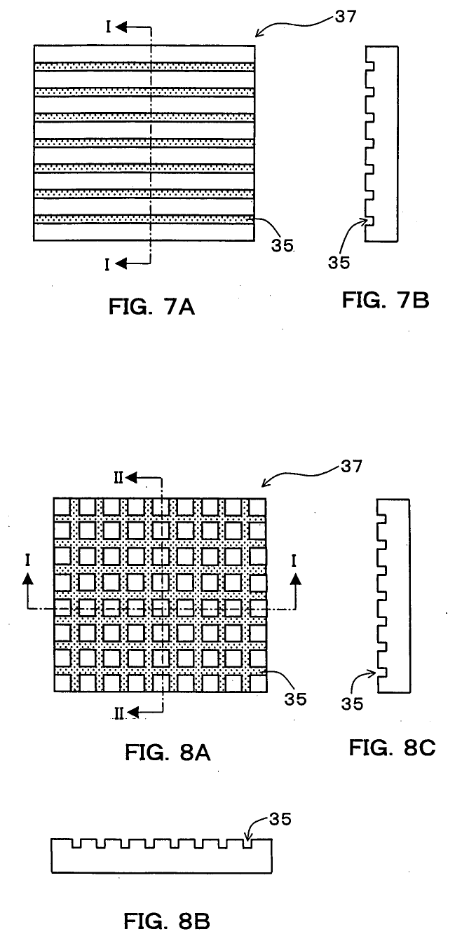

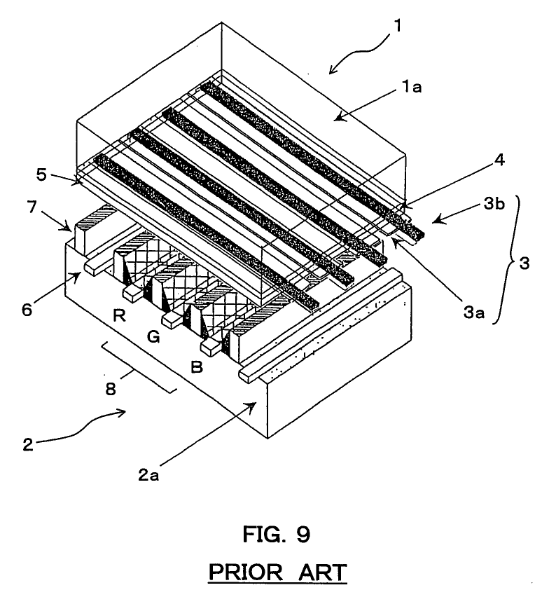

Various concrete examples of the shape of the grooves 35 are shown in FIG. 6A to FIG. 8C. FIGS. 6A, 7A, and 8A are enlarged views of an area defined by dotted lines in FIG. 5. FIG. 6B is a cross sectional view taken along line I-I of FIG. 6A. FIG. 7B is a cross sectional view taken along line I-I of FIG. 7A. FIGS. 8B and 8C are cross sectional views taken along lines I-I and II-II, respectively, of FIG. 8A.

The grooves 35 may be formed in vertical stripes as shown in FIGS. 6A and 6B, transverse stripes as shown in FIGS. 7A and 7B, or lattice as shown in FIGS. 8A to 8C. The width, pitch, depth, and the like of the grooves 35 are not limited. The grooves 35 can be formed by sandblast, etching, or the like. The grooves 35 in any shape can increase the contact area between the discharge gas and the front-side and rear-side substrate assemblies 11 and 13.

The various features shown in the foregoing embodiment can be combined. In the case where a plurality of features are included in one embodiment, one feature or a combination of plural features properly combined can be employed for the present invention.

What is claimed is:

1. A plasma display device comprising a plasma display panel having a discharge space filled with a discharge gas, the discharge space being formed inside of the panel formed of a front-side substrate assembly and a rear-side substrate assembly bonded to each other, the panel having first and second holes each extending to the discharge space, the first and second holes being coupled to each other via a pipe on the outside of the panel, wherein the first hole is in a position higher than the second hole in a normal mounting state of the panel, or a gas circulating mechanism for circulating the discharge gas is provided in the pipe.

2. The device of claim 1, wherein the first and second holes are provided in diagonal positions of the rear-side substrate assembly.

3. The device of claim 1, wherein at least one of a gas cooling mechanism, a gas purifying mechanism, and a pressure control mechanism is provided in the pipe.

4. The device of claim 1, wherein the panel has a display area, a seal layer provided so as to surround the display area, and an intermediate area between the display area and the seal layer, the first hole comprises plural portions provided in the intermediate area in an upper part of the panel in the normal mounting state of the panel, and the second hole comprises plural portions provided in the intermediate area in a lower part of the panel in the normal mounting state of the panel.

5. The device of claim 1, wherein the panel has a display area, a seal layer provided so as to surround the display area, and an intermediate area between the display area and the seal layer, and a wall part blocking the migration of the discharge gas is provided in the intermediate area on a side of the panel in the normal mounting state of the panel, the first hole is provided in a position higher than the wall part in the normal mounting state of the panel, and the second hole is provided in a position lower than the wall part in the normal mounting state of the panel.
